(19) United States
(12) Patent Application Publication
(10) Pub. No.: US 2015/0355530 A1
(43) Pub. Date: Dec. 10, 2015

(54) USER SECURED WRIST STRAP FOR CAMERA

(71) Applicants: Douglas L. James, Phoenix, AZ (US); Michelle L. James, Phoenix, AZ (US)

(72) Inventors: Douglas L. James, Phoenix, AZ (US); Michelle L. James, Phoenix, AZ (US)

(21) Appl. No.: 14/298,939

(22) Filed: Jun. 8, 2014

(51) Int. Cl. G03B 17/56; A45F 3/14

(52) U.S. Cl. CPC G03B 17/561; A45F 3/14; A45F 2003/003

(57) ABSTRACT

This is a camera strap which encircles the user's wrist in the manner of a cinching-style mechanism which is user adjustable and/or adjusted by the hanging weight of the attached camera. The strap utilizes the two connecting points on either side of the camera body. The cinching wrist strap will attach to those two connecting points via a loop of webbing and retention clips. Quick release buckles allow the user to disconnect and/or interchange straps in a quick manner. This method of attaching the camera to the user's wrist allows ease of use and offers additional security.

### CROSS REFERENCE TO RELATED APPLICATION

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Photographic camera straps are traditionally designed to hang the camera equipment around the neck of the user. However, some photographers instead choose to continually hold the camera in their hand.

Current applications of existing wrist or hand straps do not address the problem of tethering the camera securely to the user's wrist in the event of an accidental drop or attempted theft. Most camera straps currently available for the wrist are loose and do not attach snug to the user, nor do other designs attach securely to the camera by utilizing the two standard connecting points.

This design of the wrist strap utilizes both standard attachment points of the camera body and relates to the attachment of the camera to the user's wrist via a cinching manner and thereby creating an extension of the user's arm and additional security.

### BRIEF SUMMARY OF THE INVENTION

The intent of this new wrist strap is to attach the camera to the user's wrist allowing ease of use and additional security. This embodiment of the wrist strap will encircle the user's wrist in the manner of a cinching-style mechanism and attach to a typical camera in a standard method by utilizing the two connecting points on either side of the camera body.

The two connecting points of the wrist strap will attach to the camera in the same manner as a standard neck strap. The connecting points on the camera are typically located on the right and left sides of the camera body seated in its normal (horizontal) position. The wrist strap will attach to those two connecting points via a loop of webbing and retention clips. A quick release buckle is also part of this attachment thus allowing the user to disconnect and/or interchange straps in a quick manner.

The wrist strap consists of webbing which is arranged and connected via plastic retention clips and machine stitching in a manner that allows the unit to function as a cinching mechanism to the user's wrist. There is a layer of padding and a fabric cover over a portion of the wrist strap to ensure user comfort. The wrist strap is adjustable in length.

### BRIEF DESCRIPTION OF THE DRAWINGS

FIG. 1 is a perspective view of the complete camera wrist strap.

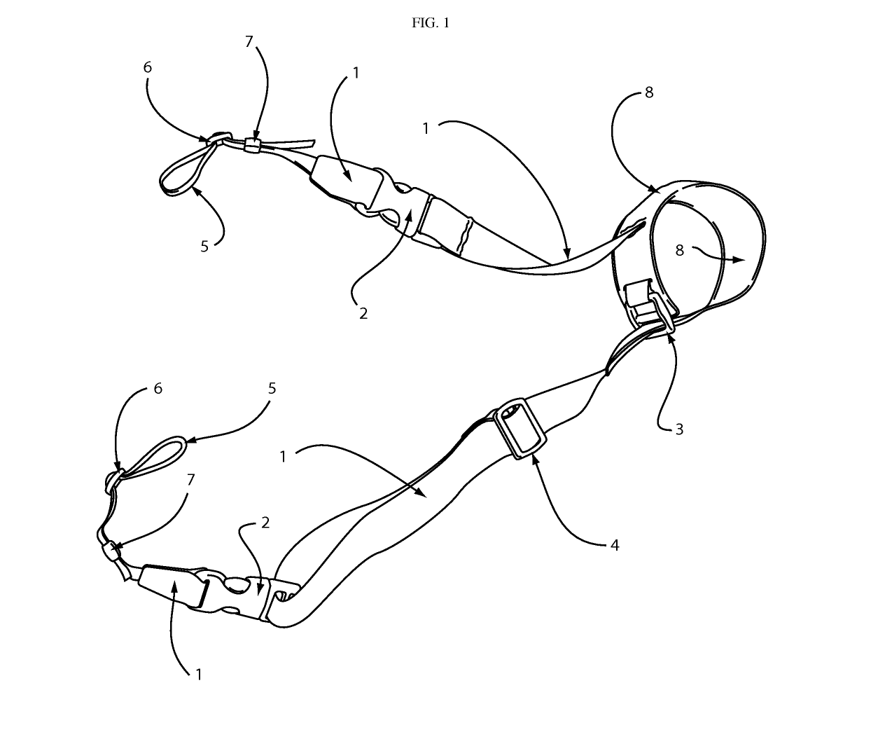

FIG. 2 shows the construction, highlighting the attachment points on the webbing to form the cinching mechanism feature of the wrist strap.

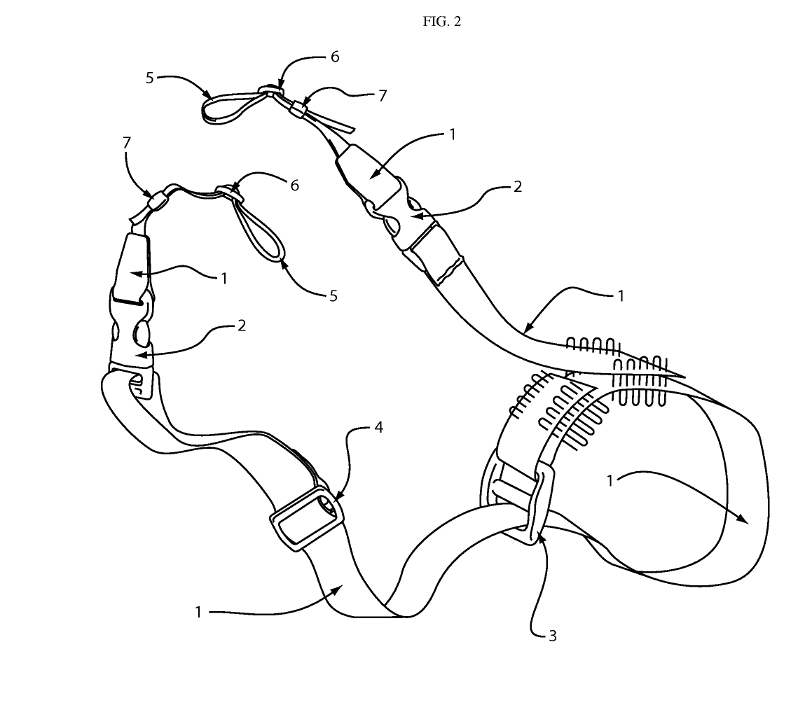

FIG. 3 shows construction of attaching points to the camera.

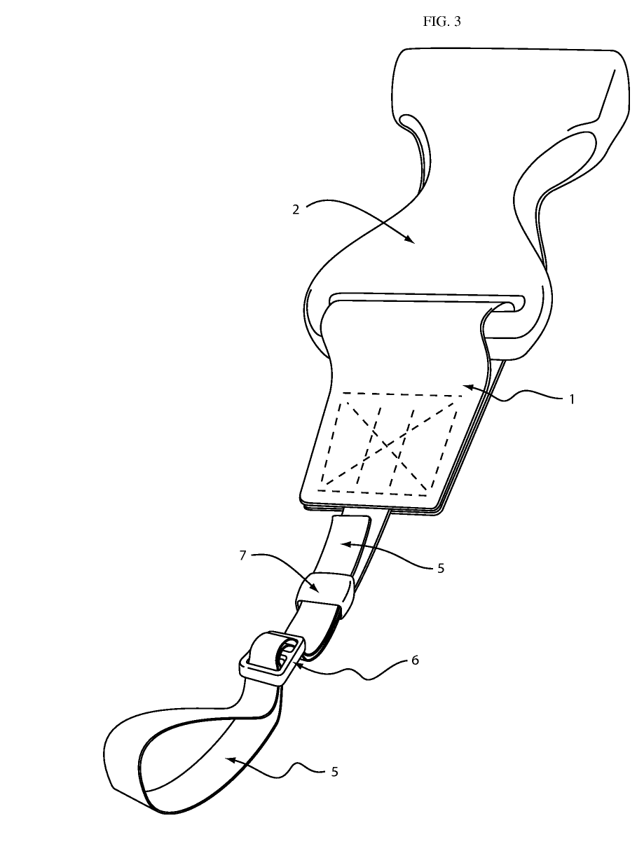

FIG. 4 is an embodiment of the wrist strap as attached to a camera and to the user's wrist.

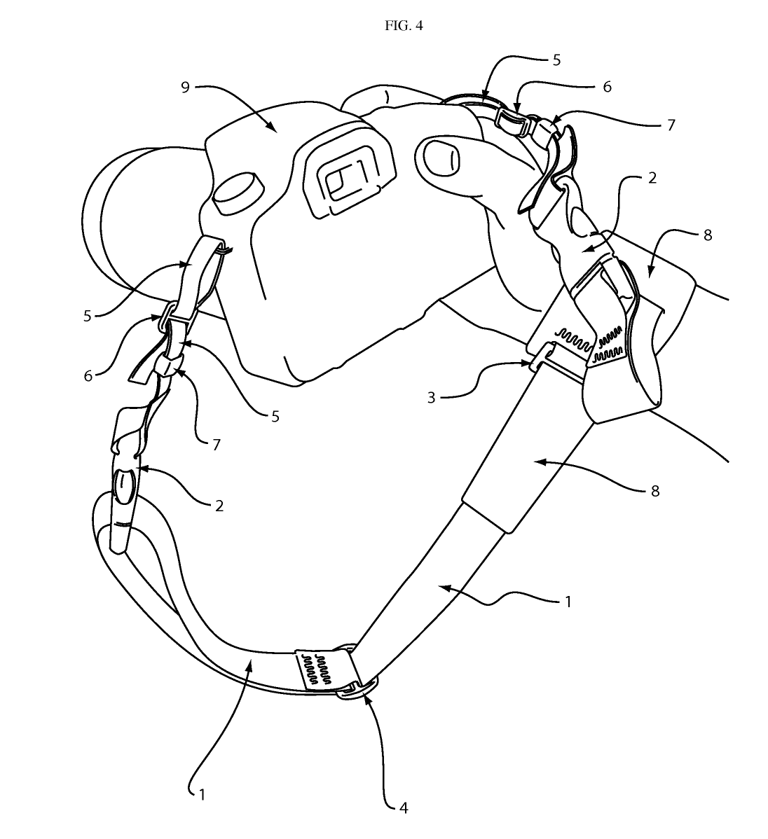

### REFERENCE NUMERALS IN THE DRAWINGS

1 webbing
2 quick release/connect buckle
3 tri-glide buckle (receives width of 1 webbing)
4 tri-glide buckle (receives width+¼″ of 1 webbing)
5 ⅜″ width webbing
6 ⅜″ strap keeper
7 ⅜″ widemouth sliplock
8 padding & material covering
9 camera body

### DETAILED DESCRIPTION OF THE INVENTION

The present invention is designed to support the weight of a typical camera body and lens by securing the camera snugly to the user's wrist.

In the preferred embodiment, the main portion of the wrist strap consists of a length of webbing 1 (e.g. nylon/polyester/cotton) which is cut to a suitable length to accommodate the circumference of a typical wrist measurement with additional length for adjustment. This is fed through an outside rung of a tri-glide buckle 3 that is at least ¼″ wider than the webbing 1, is then folded over and machine stitched in place to secure. The loose end of the webbing is then slipped through the opposite side of the same tri-glide buckle 3 in a manner that allows the unit to function as a cinching mechanism to the user's wrist.

Another tri-glide buckle 4 and quick release/connect buckles 2 which have openings that accept the same width as the webbing are now utilized.

The same unconnected length of webbing 1 is then threaded through (in & out) both sides of another tri-glide buckle 4, then through the male side of a quick release/connect buckle 2, and finally back around the center portion of the tri-glide buckle 4 and folded over and secured to itself with machine stitching. This allows for the length of the cinching portion of the wrist strap to be adjustable.

One end of a separate length of webbing 1 which is the same width of webbing used for the cinching portion of the wrist strap is then machine stitched to the cinching portion of the wrist strap. The location of the attaching point should be just above the fold-over point of the webbing where it is attached to the outer rung of the larger tri-glide buckle 3. The loose end of the webbing is then fed through the male side of a quick release/connect buckle 2, folded over and then machine stitched in place to secure.

The following process is to construct the portions of the strap that connect directly to the camera, and utilize the female side of each quick release/connect buckle 2.

Two pieces of the primary width webbing 1 are cut to an approximate length of 4″. Two pieces of ⅜″ width webbing 5 are cut to an approximate length of 11″. The standard attaching points of a camera body will accept up to ⅜″ material. One of the ⅜″ width webbing 5 pieces is then lined up from one end and down the center length of the wider webbing 1. The two pieces are then machine stitched together. This process is repeated for the remaining two pieces of webbing.

The wider piece of webbing 1, is then fed halfway through the female side of one of the quick release/connect buckles 2. The webbing should have the ⅜″ portion on the interior fold. The wider portion of webbing is then folded over and machine stitched in place to secure. This process is repeated for the remaining female side of the quick release/connect buckle.

The loose end of the ⅜″ webbing 5 is then fed through a ⅜″ strap keeper 6 and then woven through a ⅜″ widemouth sliplock 7. Leaving enough length to form a loop, the webbing is then folded back upon itself and fed back through the ⅜″ widemouth sliplock 7 and strap keeper 6. This process is repeated on the remaining female side of a quick release/connect buckle.

For the comfort of the user, a layer of padding and material 8 is attached to the portion of webbing that is intended to encircle the user's wrist. The tri-glide buckle utilized for the cinching portion of the wrist strap should allow for the easy pass-through of the padding 8.

In use, the camera strap is slipped over the user's hand and cinched snugly to the wrist. The retaining clips of the strap are connected to their companion clips of the shorter straps attached to the camera body. It is the intent that the user will primarily hold the camera body in their hand. The wrist strap provides the user some security from dropping the camera, and may also be used as a mechanism to carry the camera as it is hanging from the wrist.

1. What is claimed is a device for tethering a camera securely to the user's wrist wherein the invention is comprised of webbing, buckles, and other materials which are arranged into a cinching-style loop that will tighten to the wrist by adjustment of the user and/or by utilizing the hanging weight of the attached camera.
